(19) United States
(12) Patent Application Publication
(10) Pub. No.: US 2009/0126630 A1
(43) Pub. Date: May 21, 2009

(54) Spindle Spray Coating System

(76) Inventor: Thomas J. Boyd, Akron, OH (US)

Correspondence Address: JEANNE E. LONGMUIR, 2836 CORYDON ROAD, CLEVELAND HEIGHTS, OH, 44118, US

(21) Appl. No.: 12/060,257

(22) Filed: Mar. 31, 2008

Related U.S. Application Data
(60) Provisional application No. 60/908,948, filed on Mar. 29, 2007.

(51) Int. Cl. B05C 11/00; B05B 15/12

(52) U.S. Cl. 118/712; 118/326

(57) ABSTRACT

A spindle spray coating system including a spindle conveyor system for horizontally transporting parts supported on spindles within the system. A spindle rotation station assembly is also provided for rotating individual spindles supporting parts during spraying. A spray containment closed spray booth for containment of parts supported on spindles during the spray operation by an adjustable spray system to minimize environmental and operator exposure to the coating materials being sprayed. A second spray containment closed spray booth may also be provided for containment of parts supported on spindles during a secondary spray operation by an adjustable secondary spray system. Following the spray operation(s), a vision inspection system is used to inspect the parts that have been coated. An automated defective part rejection assembly is also provided which includes a vertical lifting mechanism, and a gripper mechanism for gripping defective parts, and lifting and rotating the parts through a 180 degree motion using a balanced counterweight, followed by release of the parts from the gripper mechanism for disposal.

### CROSS-REFERENCE TO RELATED APPLICATIONS

The present application claims priority from U.S. Patent Application Ser. No. 60/908,948, filed Mar. 29, 2007, the entire subject matter of which is incorporated herein by reference.

### BACKGROUND OF THE INVENTION

1. Field of Invention

The present invention relates to an improved manufacturing system and more specifically for an improved automated coating system for coating spindle supported products or otherwise preparing manufactured products for further manufacture and shipping.

2. Background of the Related Art

In the past, manufacturing assembly systems have required a variety of human intervention to complete the manufacture of a part, and may have resulted in poor part quality. Consistent, continuous and unassisted feeding and coating of such parts to the manufacturing system can be difficult to maintain. Additionally, manufacturing systems which apply coatings to parts often apply such coatings using a spray system. Spray coating systems often have the disadvantage that their material usage is inefficient. During the spray application of material, the material being sprayed may be “lost,” or never applied to the part to be coated.

Unfortunately, due to complicated part geometry, spray coating is often the only alternative for surface coating of intricate parts. While material losses due to overspray can be expensive, they may also result in the release of solvents or volatile organic component materials into the environment. Since such materials should not be released into the environment, prior systems may have required additional expense to reclaim such “lost” materials. Reclamation systems are typically expensive to operate, and may also result in additional waste treatment issues, for example, water removed from the reclamation system must be treated prior to release or other disposal. Examples of prior art coating systems are found in U.S. Pat. Nos. 6,998,147 and 7,294,206.

The system of the present application provides minimization of environmental issues and significantly reduces operator exposure to highly regulated chemical materials present within a variety of coating materials, particularly adhesive and paint materials. The system contains and captures, for appropriate environmental handling, greater than 99% of the volatile organic compounds resulting from the spray application of coating materials used within the system.

The use of the present system also enables isolation and containment of overspray and spillage of the sprayed coating materials within the system, thereby protecting the spindle conveyor component transporting the products during manufacture. In the past, inadvertent contamination of conveyor system components during application of the coating materials during manufacturing has resulted in expensive system maintenance and required manufacturing downtime. The use of the spray containment component in the present system, or closed spray booth, reduces or eliminates such conveyor system contamination.

### SUMMARY OF THE INVENTION

The present application provides a spindle spray coating system for the automated manufacturing of products. The system includes numerous assembly components including: a spindle conveyor system component, a preheating component, a spindle rotation station component, a spray containment component in the form of a closed spray booth, a spray system component, a vision inspection system component, and an automated defective part rejection system component.

The system of the present application provides minimization of environmental issues and significantly reduces operator exposure to highly regulated chemical materials present within a variety of coating materials, particularly adhesive and paint materials. The system contains and captures, for appropriate environmental handling, greater than 99% of the volatile organic compounds resulting from the spray application of coating materials used within the system.

The use of the present system also enables isolation and containment of overspray and spillage of the sprayed coating materials within the system, thereby protecting the spindle conveyor component transporting the products during manufacture. In the past, inadvertent contamination of conveyor system components during application of the coating materials during manufacturing has resulted in expensive system maintenance and required manufacturing downtime. The use of the spray containment component in the present system, or closed spray booth, reduces or eliminates such conveyor system contamination. The closed spray booth provides at least seven barriers to protect system components from contamination by the materials being applied during operation of the present manufacturing system. The present system provides fresh air into the closed spray booth component of the system, and removes all fumes from the entire system for any necessary further processing. Also, a quick change cleaning feature of the spray booth allows all plastic panels forming the booth to be quickly removed and replaced.

The spindle spray coating system of the present application provides reduced cycle times in order to increase product throughput by indexing and spraying multiple spindles per cycle. The present system is equipped to index at a rate of 2 parts per 1-2.5 seconds. Reduced labor costs are also obtained by improving the automation and adjustment quality of the spray system component. In particular, multiple spray guns, for example two or four, may be provided within each closed spray booth, and adjustment of each gun is provided in at least 3 axes: horizontal, vertical and an angular adjustment of approximately 60 degrees. It is understood that a smaller scale system may also be provided making use of one adjustable spray gun within the closed spray booth. A control system is also provided to electronically monitor each spindle for quality control purposes to ensure that products being manufactured are rotating properly during the spraying operation.

The vision inspection system component also provides increased quality control. The present system provides placement of a vision inspection system component following spray applications of primer materials. In the past, the failure to ensure the proper and complete application of primer materials has resulted in part operation failure. The vision inspection system component confirms that primer has been applied to each part. Additional more complex and expensive quality control inspection cameras could be added to provide additional quality control. In the event a product is determined defective due to an inadequate first application of coating material, the automated defective part rejection system component removes the problem part from the system prior to entrance into the second closed spray booth component.

Following the final coating process, a substantially closed return conveyor is also provided as a portion of the spindle conveyor system. The return conveyor enables drying of the manufactured parts being coated and return of the parts for removal to a finished part conveyor. Additionally, the return conveyor uses re-circulated air from within the system. The system provides flexibility to the manufacturing process, since modules may be added, changed or removed as needed.

Other features and advantages of the present coating system will become apparent from the following detailed description of the preferred embodiments made with reference to the accompanying drawings, which form a part of the specification.

### BRIEF DESCRIPTION OF DRAWINGS

FIG. 1 depicts a perspective view of the spindle spray coating system of the present application;

FIG. 2 partially depicts a spindle conveyor system component of the present application, with a variety of sample fixtures supporting parts to be manufactured;

FIG. 3 partially illustrates the spindle conveyor system component moving within the preheating component of the system;

FIG. 4 partially depicts the spindle conveyor system component within a chamber of the preheat component.

FIG. 5 partially illustrates the spindle conveyor system component within the preheat component chamber of FIG. 4, and showing the doors of the chamber open;

FIG. 6 partially depicts an internal view of the closed spray booth component shown in open position;

FIG. 7 partially depicts a view of four adjustable spray guns provided within the closed spray booth component of the present system;

FIG. 8 partially depicts a portion of the spindle rotation station component of the system, located adjacent the closed spray booth component;

FIG. 9 partially depicts a further detailed view of the spindle rotation station component, and in particular the gear drive mechanism of the belt drive assembly;

FIG. 10 partially depicts a portion of the closed spray booth component at the spindle rotation station, where the closed spray booth is in the open position;

FIG. 11 partially depicts a portion of the closed spray booth component at the spindle rotation station, and with one spindle having a fixture with a part shown supported on the fixtured spindle;

FIG. 12 partially illustrates a perspective view of one embodiment of the present system having a first closed spray booth component of the present system, preferably for spraying primer coating materials, and illustrated at the right in an open position, and having a second closed spray booth component, shown on the left and behind a metering system for supplying the desired coating materials to the closed spray booth components;

FIG. 13 partially illustrates the spindles supported on the conveyor system component in a post processing or cure chamber;

FIG. 14 partially illustrates the exhaust venting and intake filters provided adjacent the cure chamber of the present system;

FIGS. 15, 16, 17 and 18 partially illustrate the vision inspection system component of the present system and the automated defective part rejection system component, which are illustrated in a variety of operating positions;

FIG. 19 partially illustrates the cure chamber, and the interconnected main control panel for the present system;

FIG. 20 schematically illustrates six of the protective barriers provided to the conveyor system component of the present system;

FIG. 21 is a schematic, perspective view of the system of the present application;

FIGS. 22a and 22b are partial, schematic top and side views, respectively, of the system shown in FIG. 21;

FIGS. 23a to 23d are partial, schematic front, side, perspective and cutaway views of the chamber doors of the closed spray booth component, respectively;

FIGS. 24a to 24d are partial, schematic illustrations of one side portion of the closed spray booth component of the present system;

FIGS. 25a to 25d are partial, schematic illustrations of a side portion of the closed spray booth opposing the one side portion illustrated in FIGS. 24a to 24d;

FIGS. 26a to 26d are partial, schematic illustrations of perspective, side, front and top views, respectively, of the chain and spindle assembly of the conveyor system component, at the spindle rotation station during spraying

FIGS. 27a and 27b are partial, schematic bottom and side views, respectively, of the closed spray booth component in the open position;

FIGS. 28a, 28b and 28c are partial, schematic illustrations of the closed spray booth component in open position for cleaning, an index position during conveyor movement into the spindle rotation station for spraying, and in fully closed position, respectively;

FIGS. 29a and 29b are partial, schematic illustrations of the spindle rotation station assembly and the adjustable spray gun in a vertically low and right angle spray gun position, and with the adjustable spray gun in a vertically high and 60 degree angled spray gun position, respectively;

FIG. 30 partially and schematically illustrates the support and adjustability mechanisms for movement of the adjustable spray guns;

FIGS. 30a to 30f are partial, schematic illustrations of the drive assembly of the spindle rotation station component as shown in an open position, a closed position, a top view, a side view, an end view and a cut away taken along the line A-A in FIG. 30c, respectively;

FIGS. 31a to 31e are partial, schematic illustrations of the automated defective part rejection system component in a camera inspection system view position, in a dump, release or eject position for removal of rejected parts, and front, top and side views of the dump, release or eject position, respectively;

FIGS. 32a to 32e are partial, schematic illustrations of the automated defective part rejection system component in the start, start product grip procedure, up position, halfway from the up position to the dump or reject position, in the full dump position, and in the release position to remove the rejected part, respectively;

FIGS. 33a to 33e are partial, schematic upside down illustrations of the gripper mechanism of the automated defective part rejection system in the grip position, release position, front view, top view and side view, respectively;

FIGS. 34a to 34c are partial, schematic illustrations of the horizontal lifting mechanism which supports the gripper mechanism, as shown in the start position, lift up position and the release or dump position, respectively; and

FIGS. 35a to 35e schematically illustrate a small scale version of a spindle spray coating system of the present application, which makes use of a closed spray booth component having a single spray gun and 8 spindles on a conveyor component within the system of the present application, and specifically a perspective view, cutaway perspective view, end view, side view and top view, respectively.

### DETAILED DESCRIPTION OF THE PRESENT SYSTEM

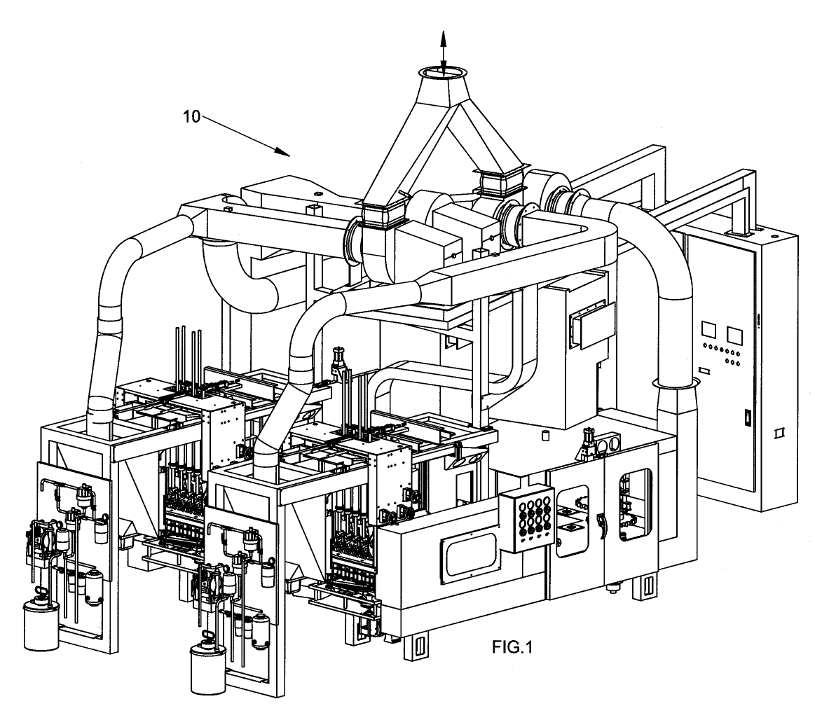

Turning now to the illustrations of the embodiments of the system of the present application, a multi-station manufacturing system 10, shown in FIGS. 1, 21, and 35a to 35d, provides flexibility and improved coating material control in the coating processes used in connection with completion of the items to be manufactured C. The system 10 is supported on a modular frame 11 and includes work stations positioned along a conveyor system 25 which continuously feeds items C to be coated.

All system operations are automatic and controlled by a Mitsubishi Q series programmable logic controller and a Mitsubishi E1100 series operator interface. Additionally, a variety of other system controllers may also be used, for example, IEC style pushbutton switches, and Guard Master safety relays and emergency stop buttons, as well as other conventional controllers, all of which are well known to one of ordinary skill in the art and are collectively referred to herein as the central control system 12. Operation of the central control system 12 and its numerous controller, drive, sensor and switch components are provided at the operator interface terminal 14, positioned as desired by an operator.

The system 10 includes a spindle conveyor system 25 for moving parts being manufactured through the system 10 on rotating spindles 28. Also provided are a preheating component 16, a spindle rotation station component 18, a closed spray booth spray containment component 20, a spray system component 21, a vision inspection system component 22, a curing component 23, and an automated defective part rejection system 24. The control system 12 controls position and movement of the items C through the system 10 at desired locations and specified speeds. The frame 11 comprises metal support members for supporting and defining the conveyor system 12 and the closed spray booth 20, for example.

Certain environmental, electrical and valve components of the control system 12 are provided within cabinets 13 located within the modular frame 11 as shown. The improved cabinets 13 are fully insulated and include insulated doors upon which electrical components may be mounted, and which also enable ready access to the controls for repair and cleaning. Additional system units, such as material supply or take-away units, for example, may also be secured to the modular frame, and preferably at corner locations such that ready access to the units is provided upon removal of the adjacent doors or safety panels. Likewise, electrical connections are provided adjacent frame openings and connections are preferably quick disconnect type components to permit quick change out of modular system components.

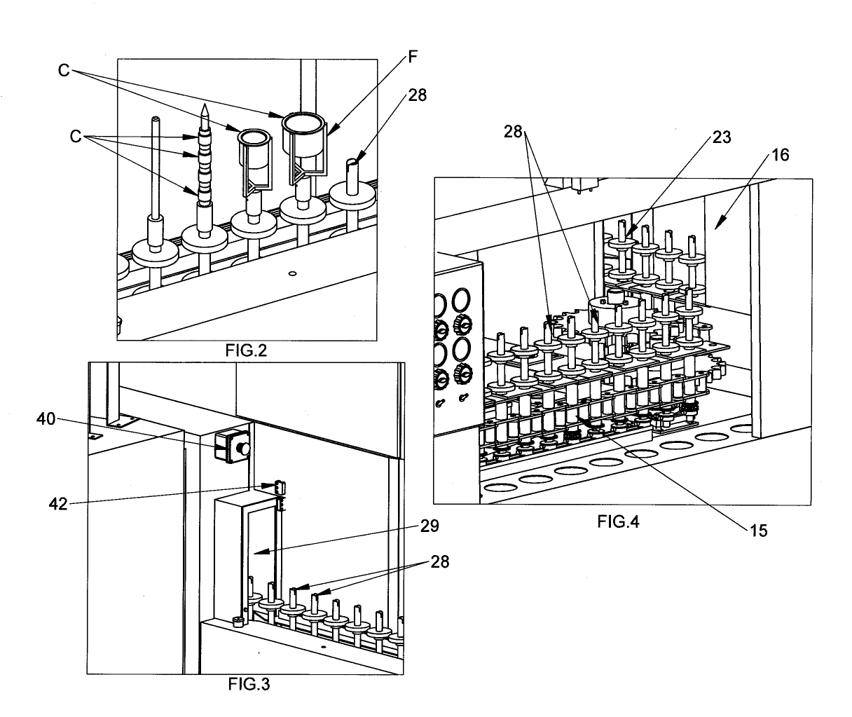

FIG. 1 illustrates the spindle spray coating system 10 for applying spray coating material(s) to items C, which items may have a variety of configurations, as further illustrated in FIG. 2. The items C shown may be axially aligned and supported directly on a spindle 28 for coating an external surface of the item C, either individually or with multiple items. Alternatively, the items C may be supported on a fixture F which itself is axially aligned and supported on a spindle 28, for coating an internal surface of the item C.

It should be understood that the embodiment of the system 10 illustrated includes multiple spraying components and curing components, and that processing of the items C is accomplished at numerous stations. In a first station 30, within the preheating component 16 or oven, the items C may be preheated or otherwise prepared for later stations. At a second station 32, or at the spindle rotation station component 18 within the closed spray booth spray containment component 20, the spray system component 21 may be operated to apply a first coating material or primer material to the items C. The items C then proceed via the conveyor system 12 supported on the spindles 28 to either a second or third coating application station, where a secondary and/or any finish materials are applied to the items, or to further curing component stations 23. Prior to exiting the system 10, the items C are reviewed for quality control by the vision inspection system component 22, and in the event the items C do not meet the necessary quality standard, the items are removed from the system 10 using the automated defective part rejection system 24. As the components of the spray booth 20 and heating or curing components 16, 23 are substantially similar, each of the systems will be referred with a prime designation, with only certain differences highlighted between the systems in further detail.

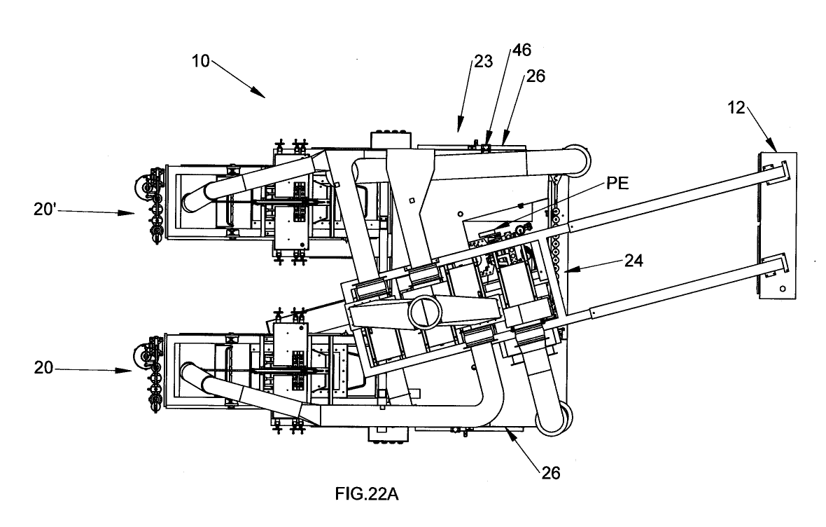

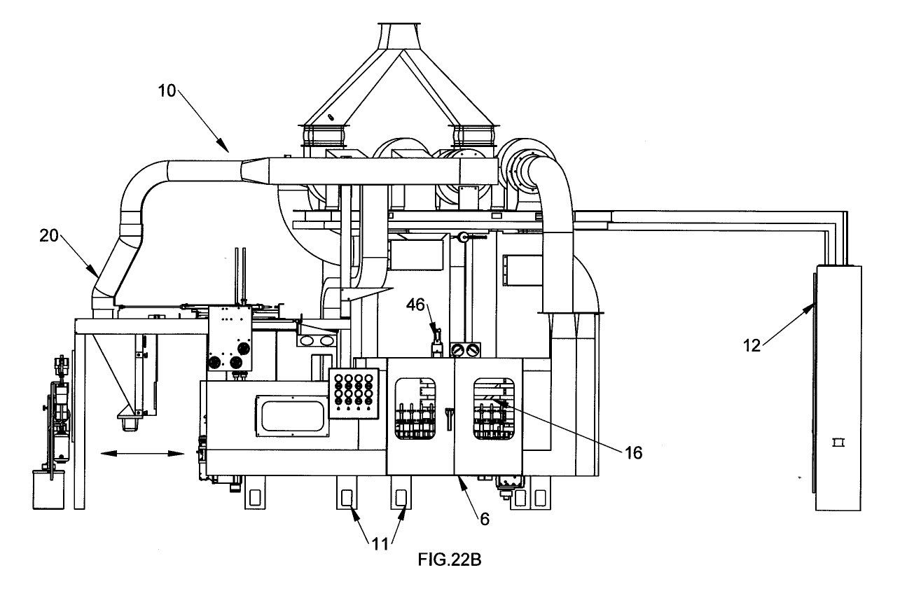

As shown in FIGS. 2-6, 10-1, 15-19 and 21-22b the conveyor system 25, spray booth 20 and preheating and curing components 16, 23 are supported on the frame 11 enclosed within walls and hinged doors or covers 26, which are also supported on the frame 11. The use of walls and doors 26 with openings permits the operator to view the system 10 during operation, while preventing exposure to the system's moving parts, or fumes from harmful materials being applied. The openings in walls and covers 26 are sealed using a clear synthetic resin material, for example Tempered Glass. The resin material is mounted for quick removal and replacement for easy cleaning of the system 10. Additionally, internal surfaces of the spray booth 20 may be lined with removable plastic liner for additional clean-up speed.

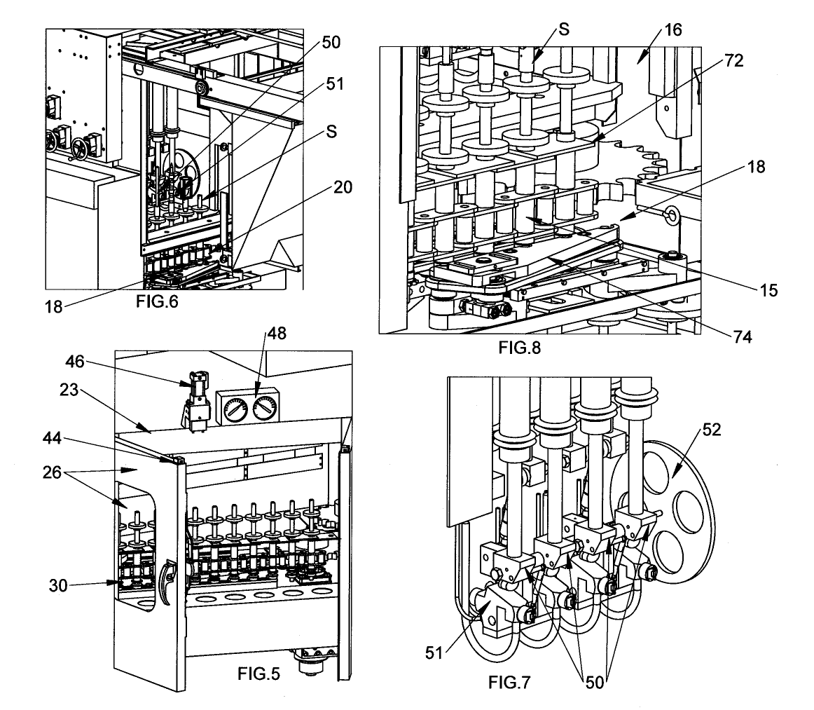

Turning to FIG. 3, the spindle conveyor system component 25 is shown moving the spindles 28 through an opening 29 into a preheat component 16 of the system 10. FIGS. 4 and 5 illustrate the preheat component 16 as a preheat oven for heating the metal items C to be manufactured prior to coating. The preheat 16 and curing ovens 23 in the present embodiment are preferably provided with New York Blower fans and Watlow electric heaters. The conveyor component 25 within the preheat oven provides a series of take ups, which may be adjusted to enable the items C to remain within the preheat oven for the desired length of preheat time. An electric motor drive, a Sew EuroDrive, is used to drive the conveyor component 25. The preferred conveyor chain 15 is a modified Tsubaki chain. It is noted in FIG. 3, that a safety stop 40 for operator termination of the system is provided, as well as a vision inspection camera 42 of the vision inspection system 22 to monitor fixture F presence on each of the spindles 28 entering the preheat oven 16.

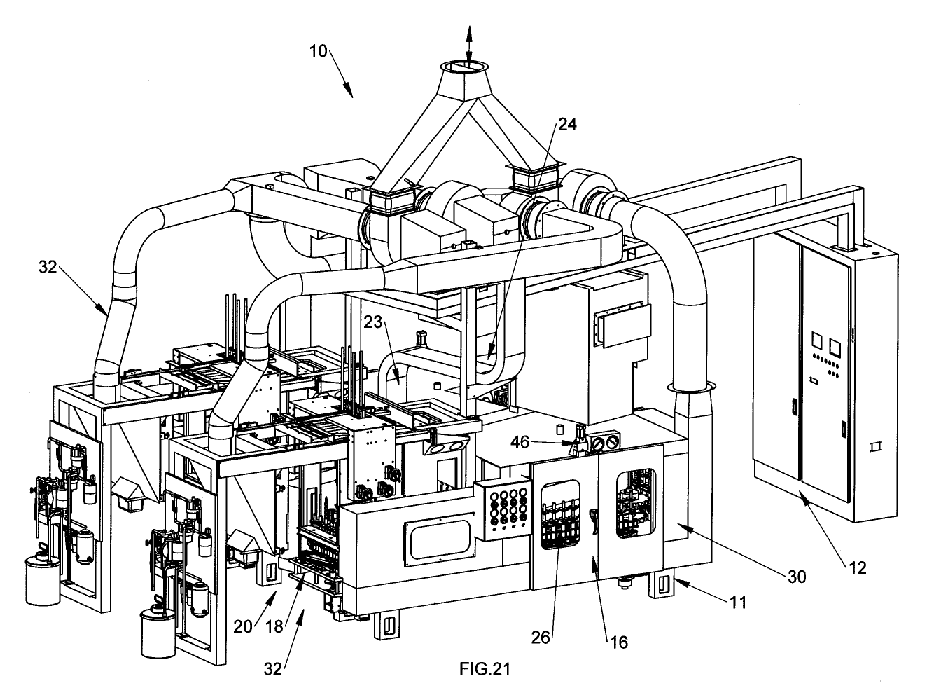

As shown in FIG. 5, cover or door interlock switches 44 are also positioned adjacent each hinged cover 26, and are electrically interconnected to the control system 12. In the event the covers 26 are manually opened during operation of the system 10, instead of opened via the pneumatic air cylinder 46 illustrated in FIGS. 5 and 21, the interlock switches operate to halt operation of the conveyor system 25. Such safety interlocks ensure that the operator cannot access the system during operation.

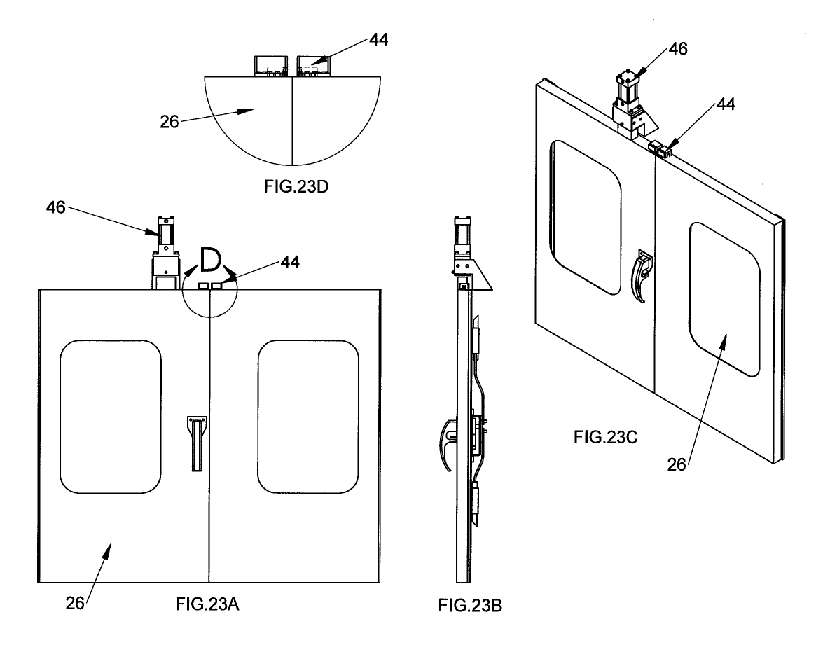

FIG. 5 further depicts the spindle conveyor system component within the preheat oven 16 component of FIG. 4, where the hinged doors 26 are open. Again, the pneumatic air cylinders 46 are used to maintain the doors in closed position, and are interconnected with interlock sensors 44 or safety eyes which may be fiber optic sensors, positioned to monitor door position, as shown. Additional pressure sensors 48 are provided between chambers or components of the system, for example within the preheat component 16 and closed spray booth component 20, and are used to monitor pressure differentials between the chambers. FIGS. 23a to 23d provide additional schematic views of the chamber doors 26.

Upon completion of preheating at the first station 30, the spindle conveyor component 25 moves the items C to a second station 32 for spray coating of the desired coating material. In FIG. 6, the items C are depicted within the closed spray booth component 20, which is shown in the open position. The closed spray booth 20 permits the spindles 28 supporting items C to be sprayed to be closed and completely surround the items during the spraying operation.

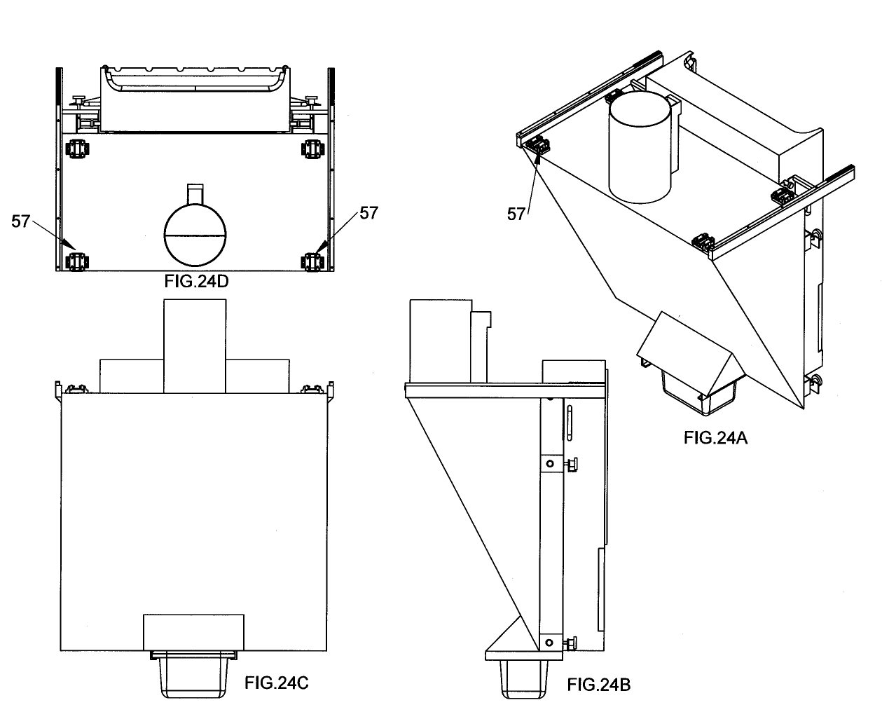

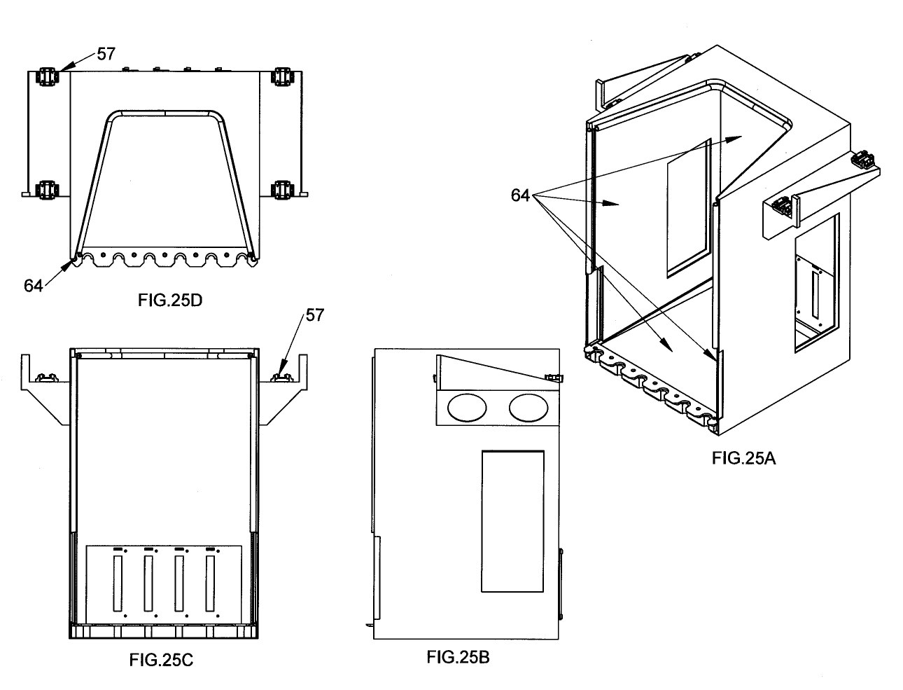

The closed spray booth 20 is formed in two halves, with the first half 54 illustrated in FIGS. 24a to 24d, and the second half 56 illustrated in FIGS. 25a to 25d. Within the spray booth 20, a spray system component 21 is provided, including a desired number of material spray guns 50 to spray the corresponding number of spindles 28 supporting the items to be coated. In the embodiment of FIG. 7, four spray guns 50 having nozzles 51 are provided within the closed spray booth component 20, which enables four spindles 28 supporting items C to be coated during one operation cycle or closing of the spray booth 20. In the embodiment of the present system, Anest Twata or Turbospray guns are used. A safety interrupt feature is provided in the form of a round wheel 52. In the event the round wheel 52 contacts or is moved by a spindle 28 or other element during operation of the system 10, the system is automatically shut down.

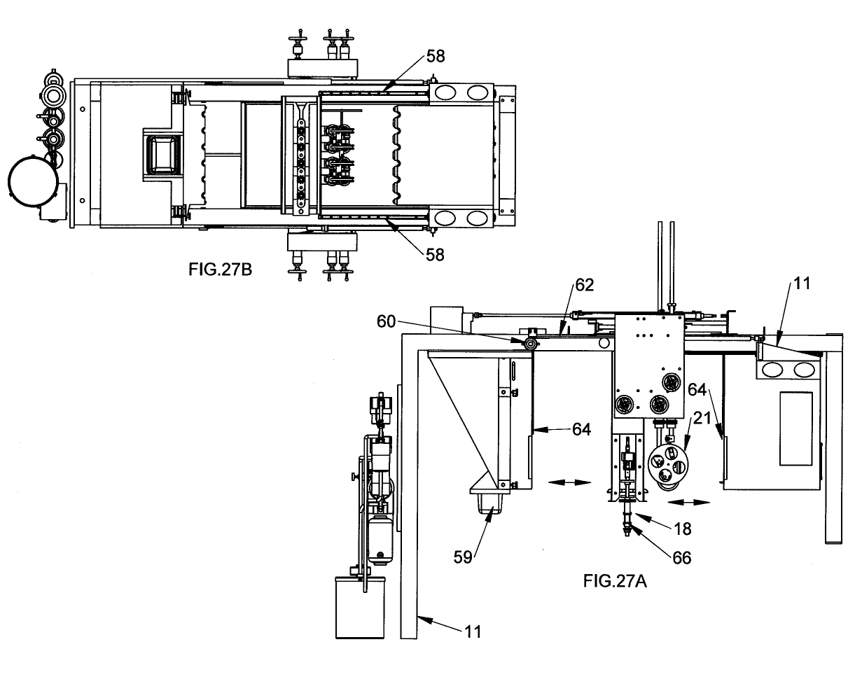

As more fully shown in FIGS. 27a, 27b, the first and second halves 54, 56 of the spray booth 20 are supported for sliding engagement on the frame 11. Each half 54, 56 of the spray booth 20 includes linear rail bearings 57, mounted on the top surfaces of each of the first and second halves 54, 56 for supporting sliding engagement of the spray booth components on rails 58 mounted on the frame members 11. The first and second halves 54, 56 are driven between open and closed positions along the rails by a gear 60 engaged with a gear rack 62 also engaged with the first and second halves. As the gear 60 is actuated by the control system 12 using a pneumatic cylinder, the first and second halves are simultaneously moved between open and closed position in the directions indicated by the arrows, by gear 60 movement driven along the gear rack 62. Sealing engagement along rubber seals or gaskets 64 is provided between the first and second halves when in the closed position. A run off box 59 is provided to receive coating material from which drains from within the first half 54 of the spray booth 20 along the slanted rear surface onto which coating material is sprayed during operation.

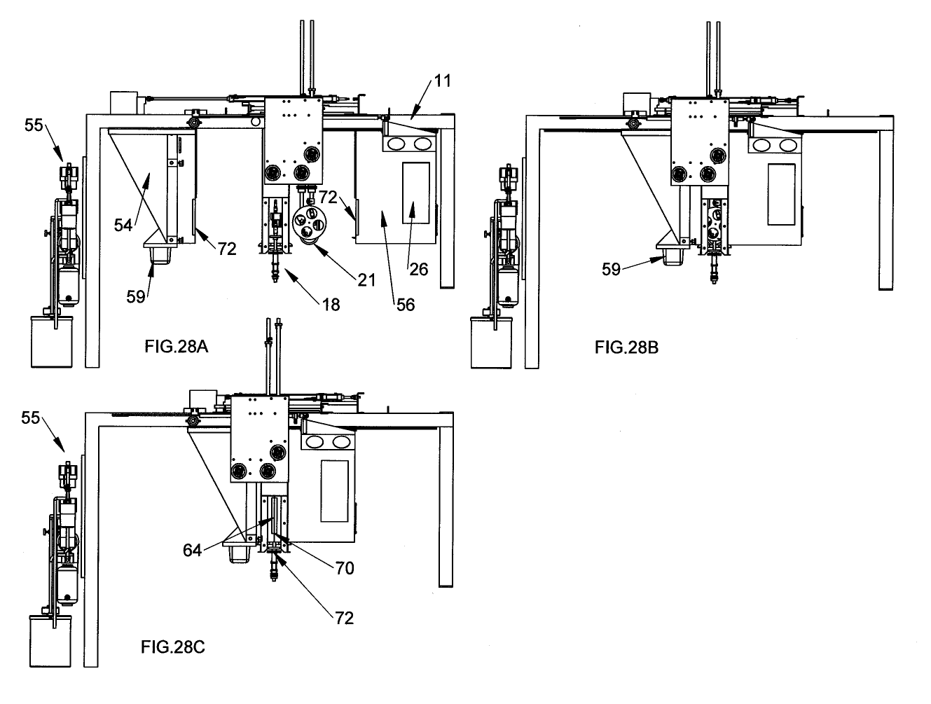

Also shown in FIGS. 6, 12, 27a and 27b are additional views of the closed spray booth component in open position, with the portions of the spindle rotation station component 18 illustrated in position below the spray booth 20. FIG. 28a also illustrates the closed spray booth component in open position for easy cleaning. FIG. 28b illustrates the closed spray booth component in index position, during which time the conveyor system component 25 moves spindles 28 loaded with items C to be coated into the spindle rotation station 18 position for spraying.

During indexing of the spindles 28 through the system 10 on the conveyor system 25, the two halves 54, 56 of the spray booth 20 need not be fully opened, but only opened sufficiently to provide passage of the spindles 28. FIG. 28c schematically illustrates the closed spray booth component in fully closed position and ready for operation of the spindle rotation station 18 and the spraying operation using the spray system components 21, with the spindle mount assembly 66 extending from below the closed spray booth 20.

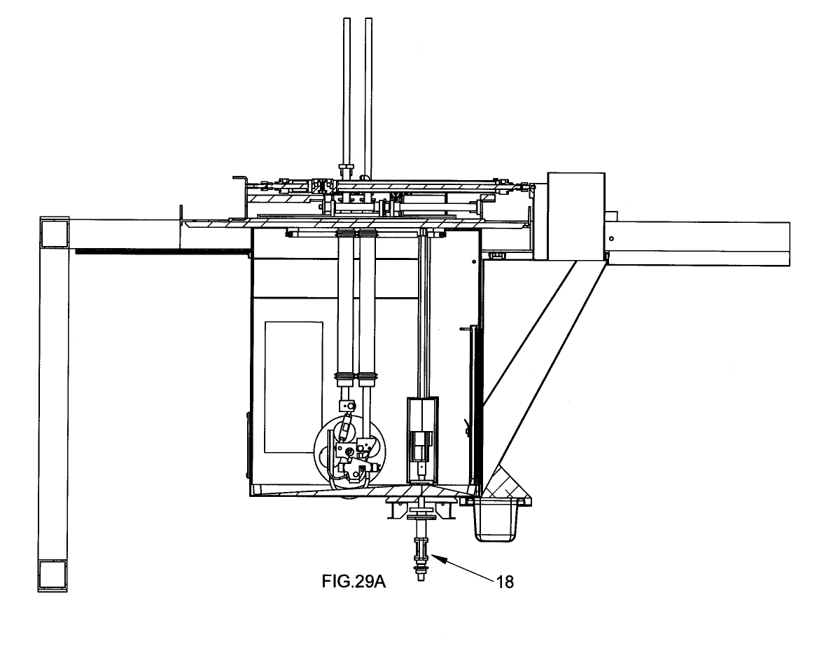

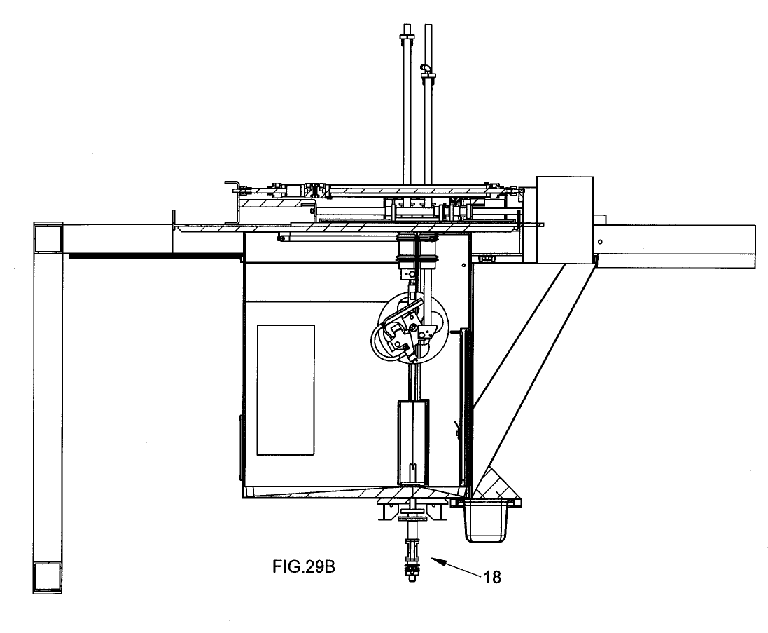

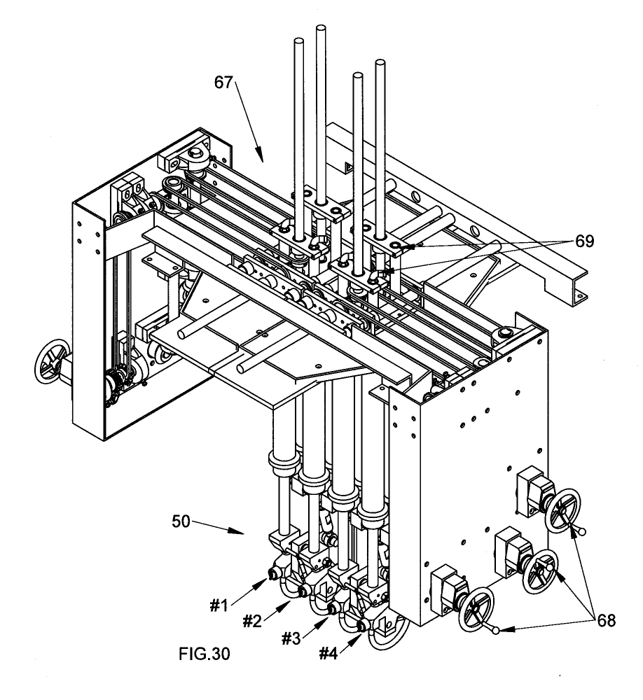

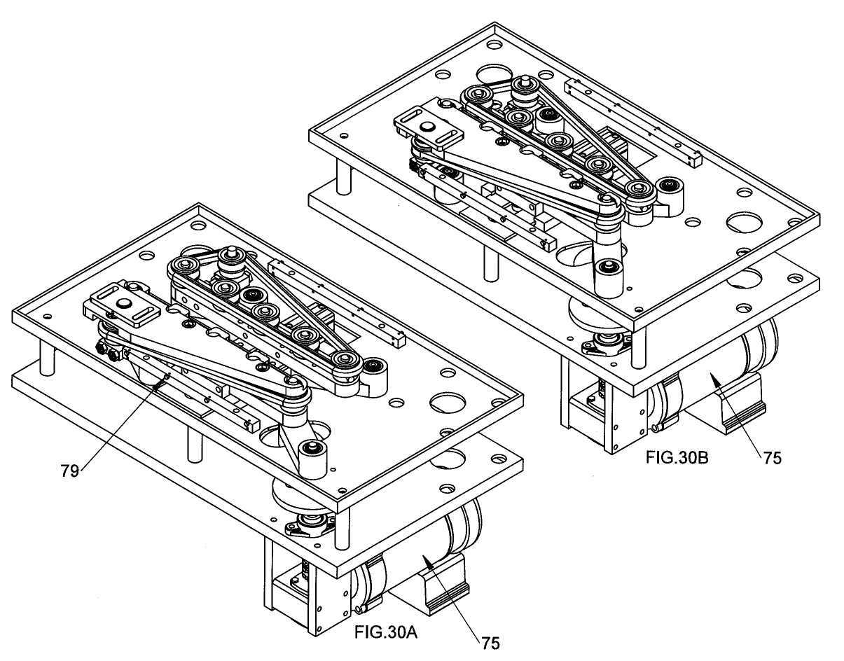

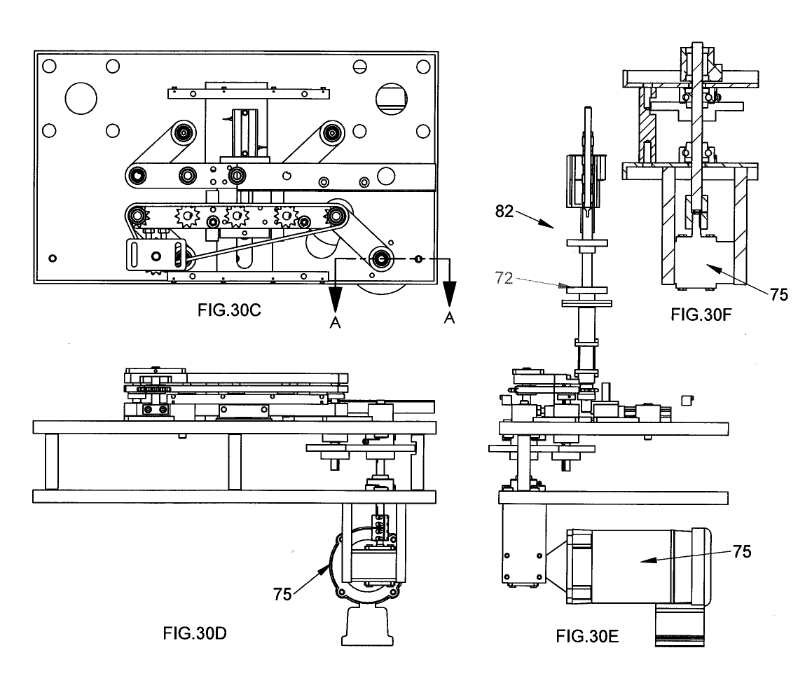

FIG. 29a also illustrates the position of the spindle rotation station 18 and spindle mount assembly 66 with respect to the adjustable spray guns 50, shown in a vertically low and right angle spray gun position. FIG. 29b illustrates the position of the spindle rotation station assembly with respect to the adjustable spray gun 50, shown in a vertically high spray gun position. FIG. 30 illustrates the horizontal and vertical supports, belt driven carriages 67 and adjustability mechanisms 68 for movement of the spray guns 50 through the horizontal, vertical and angled nozzle 51 positions. To provide the spray guns 50 with the necessary air and coating materials, the air and coating supply lines are provided through shafts 69.

When the spray booth 20 is in the fully closed position illustrated in FIG. 28c, in addition to the rubber tube gasket seals 64 provided at the edges of each half of the booth 54, 56, plastic butt seals 70 are also provided. Still further, overlapping plastic plates 72 provide additional seals over the conveyor system 25. The present system also provides numerous other sealing mechanisms for protecting the conveyor system component 25 and the spindle rotation station component 18 from coating material dripping down into the components and preventing their operation. It is noted that the desired coating materials are provided to the spray system components 21 from material supply equipment 55 located adjacent the first half of the closed booth 54.

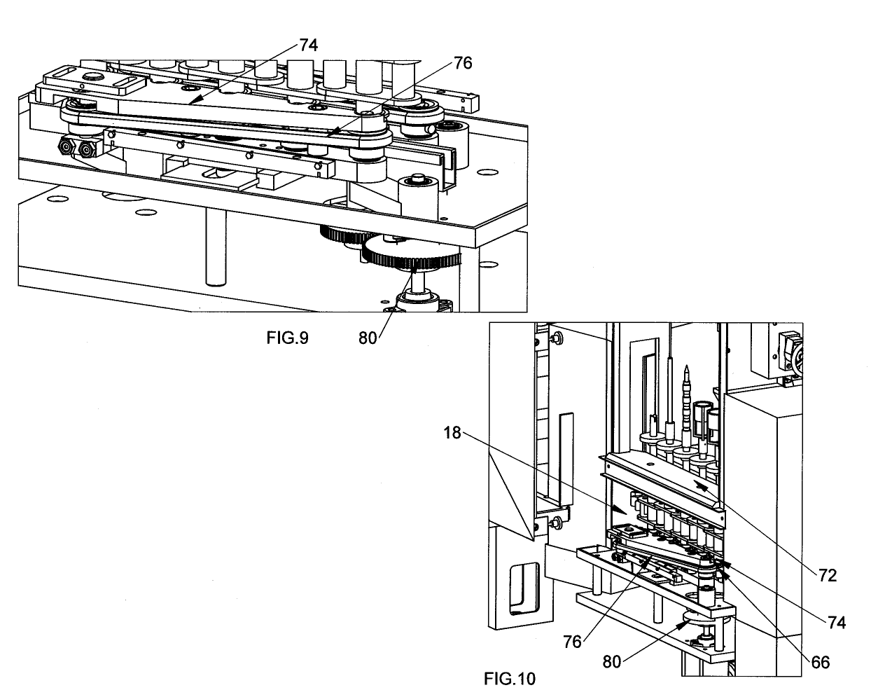

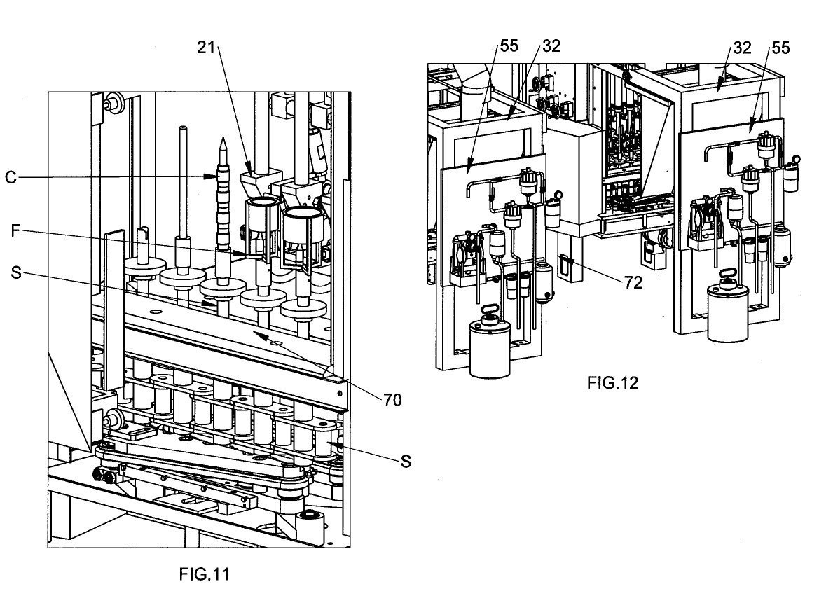

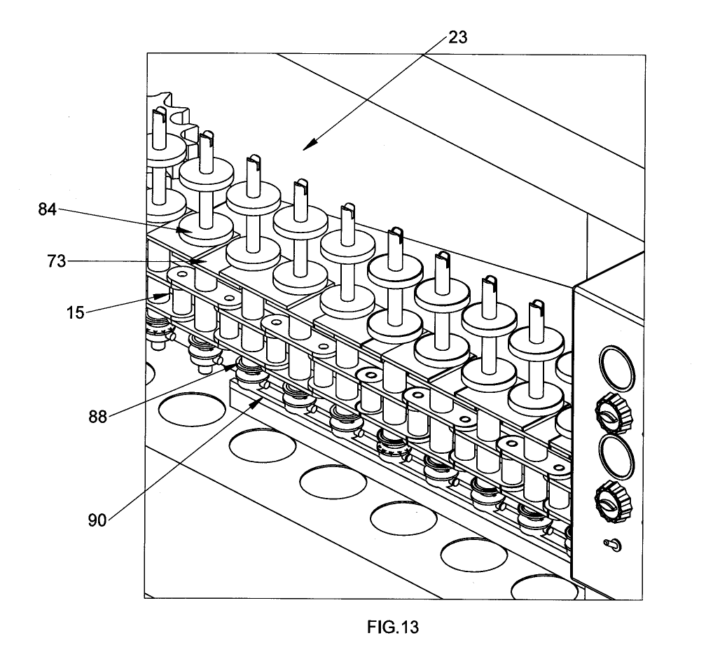

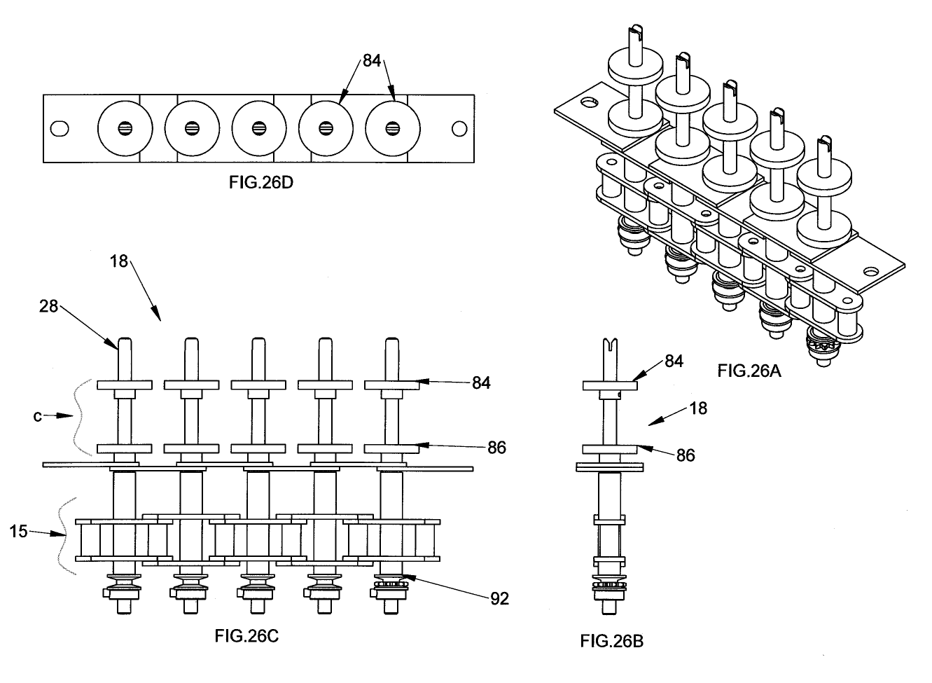

FIGS. 8-11 and 30a to 30f depict the spindle rotation station component 18 adjacent the closed spray booth 20. Upon being appropriately indexed into the spray booth 20 and having the spray booth 20 driven to the closed position, all under control of the control system 12, the spindles 28 are rapidly rotated while a spraying operation is performed using the spray system components 18. To rotate the spindles S, a drive assembly 74 of the spindle rotation station component 18 is driven by an explosion proof motor 75 which drives one side of a belt drive 76 shown here, and in FIGS. 9 and 10, on the driven side of the spindle mount assemblies 66. A tension pulley 77 is provided within the belt drive assembly in FIG. 8 to ensure engagement of the belt 76 with the spindles S. As shown in FIGS. 30a to 30f, a similar belt 76′ engages the spindles 28 on the opposite side of the belt drive assembly 74, to provide equal wear on the spindles 28 during their rotating movement. When driven in one direction, the belt drive 76 tends to pull itself in or out depending on the driving direction. The use of an opposite belt drive, or two sided belt drive, equalizes the forces applied on both sides of the spindle rod. Additionally, a bronze bearing 78 is provided at the base of the assembly to provide additional load bearing support. A vision eye 79 is provided under the closed spray booth component adjacent the spindle rotation station to ensure continuous rotation of the spindles during spraying. FIGS. 26a to 26d provide additional schematic illustrations of a portion of the chain and spindle assembly provided at the spindle rotation station during spraying.

FIG. 9 depicts a further detailed view of the spindle rotation station component 18, and in particular the gear drive mechanism 80 of the belt drive assembly 74. FIGS. 30a to 30f illustrate various aspects of the drive assembly 74 of the spindle rotation station 18. FIG. 30a illustrates an open position, where the drive belts 76, 76′ are open for loading or indexing of spindles 28 into the spindle rotation station component. FIG. 30b illustrates a closed position for engagement of the drive belts 76, 76′ with the spindle assembly 66 for rotation of the spindles 28 during the spraying operation. FIGS. 30c to 30f show details of the top, side, end and cut away views of the drive assembly 74.

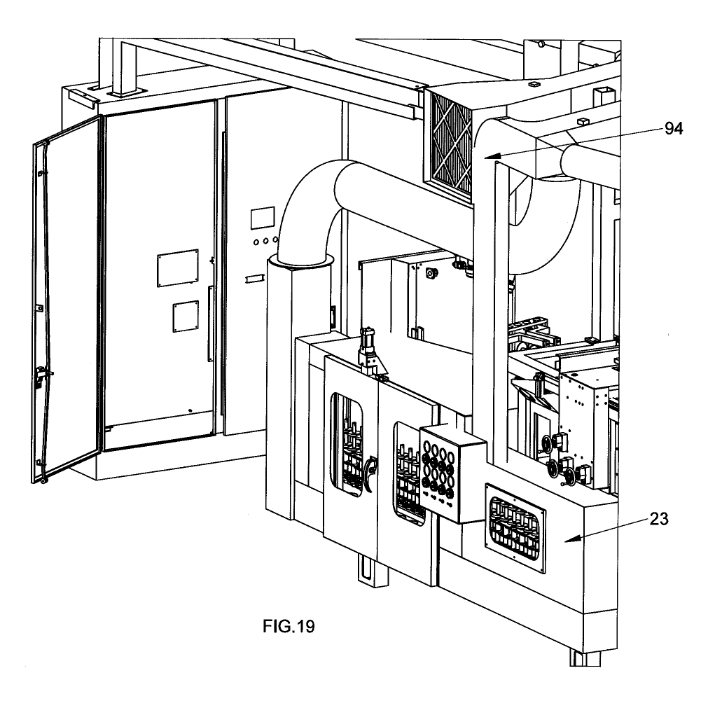

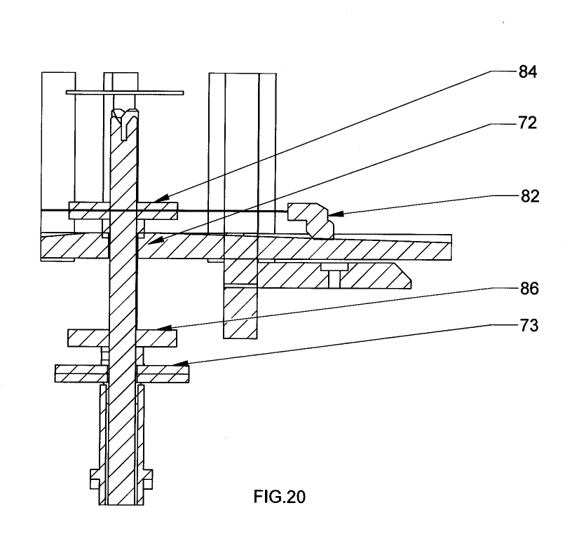

FIG. 10 shows a portion of the closed spray booth 20 at the spindle rotation station 18, with the closed spray booth 20 in open position. FIG. 11 is a similar view to that of FIG. 10, but with a fixture F having an item C therein shown supported on a spindle S. The spray guns 50 are shown above the fixture F. Additionally, several of the barriers provided to prevent contamination of the conveyor component 25 are also shown, such as an air knife component 82 which is used to move air above the spindle mount assemblies 66 to prevent downward movement of coating material. An overspray disk 84 is also used as shown mounted on the spindle S. When moved to the closed position the plastic layers 70 of the closed spray booth form a clamshell or butt seal surrounding the four spindles 28 at the spindle rotation station 18. One side of the protective shingle 72 is also shown which covers a portion of the clamshell seal. A still further layer of protection is shown in FIG. 4, where additional overlapping layers of plastic 73 are provided under the overspray disk 84. A lower disk 86 is also provided under the clamshell seal. Plastic chain link covers 88 and a chain guide 90 may also be provided as shown in FIG. 20 and FIGS. 26a to 26c. Using numerous levels of defense to prevent contamination of the chain 15 increases the reliability of continuous operation of the conveyor component 25 of the present system. The use of the present system provides isolation and containment of overspray and spillage of the sprayed coating materials within the system, to protect the conveyor component 25 transporting the items C during manufacture

In the present embodiment, a first closed spray booth component 20 of the present system, preferably for spraying of primer coating materials at a second station 32, is provided in open position in FIG. 12, and a second closed spray booth component 20′, at a second station 32′, shown behind a supply and metering system 55′ for supplying the desired coating material to the second closed spray booth component 20′. It should be understood that the illustrated system is provided with two closed spray booth components, each having four spray guns 50. However, any desired combination of closed spray booths and spray guns may be provided. The spray guns 50, 50′ are each movable horizontally, vertically, and about a 60 degree axis of rotation.

Following the spraying operation in the second coating station 32′, the spindles on the conveyor system component 25 are indexed to a post processing or cure component 23. In this cure chamber or oven, additional solvents are removed from the environment surrounding the parts and outside air or filtered air is re-circulated into the chamber. Further barrier elements are also shown, such as the link covers 88, each mounted on two adjacent spindles, are also provided under the upper overspray disks 84 to additionally protect the links from contamination. The chain guide 90, surrounding the spindles 28, is also shown. The chain 15 provided is a four inch link chain, having two bronze bearings 92. In the present system, two spindles 28 are timed to move and index together as they move through the system. Likewise, the four spray guns 50 within each of the two closed spray booths 20, 20′ at the spindle rotation station 18 components must be timed to operate together. Take-up adjustments are provided on each side of the closed spray booth 20 component to make necessary spacing adjustments, for example in the pre-heat 16 and cure 23 oven components.

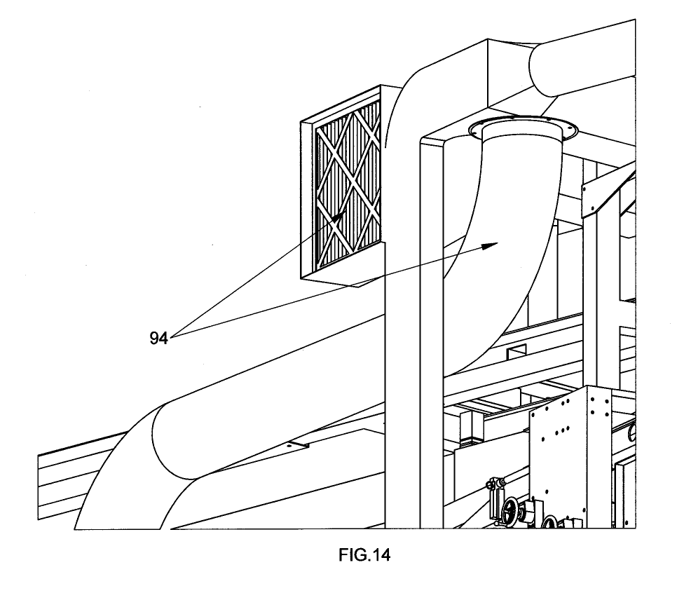

Exhaust venting and intake filters 94, as shown in FIGS. 14 and 19, are provided adjacent the cure chamber 23. Exhausted air containing solvents is removed for treatment, for example for burning in a roof incinerator, not shown. By removing and treating the exhaust air, environmental issues are minimized by the spray operations of the present system, and the closed spray booth additionally and significantly reduces operator exposure to highly regulated chemical materials. FIG. 19 depicts the cure component 23 through which items C are conveyed on the conveyor component 25 following the second spray application, and the interconnected main control panel 12 for the system 10.

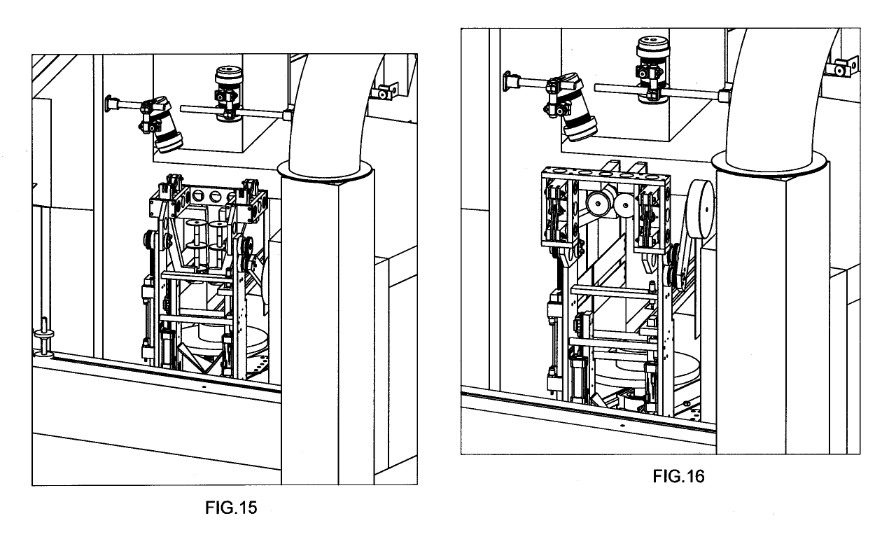

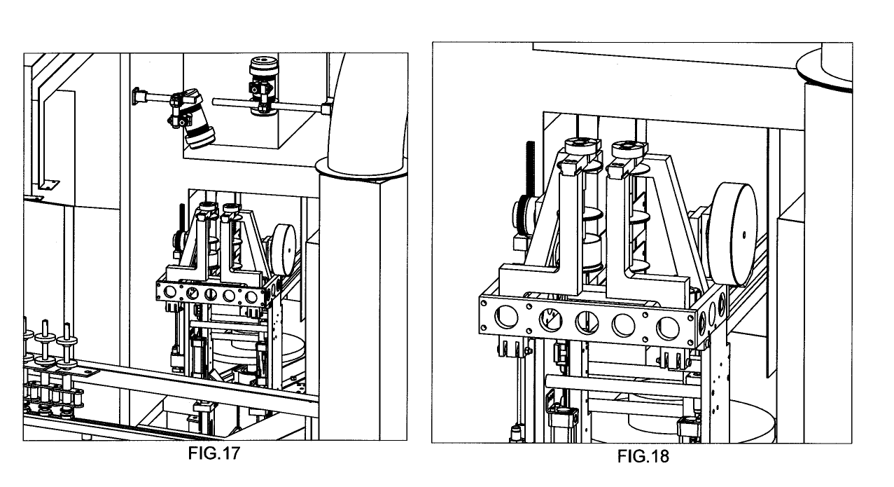

FIGS. 15, 16, 17 and 18 depict the vision inspection system component 22 and the automated defective part rejection system component 24 provided by the present system. The automated defective part rejection system 24 is illustrated in a variety of operating positions for purposes of clarity of each of the steps provided. The vision inspection system 22 includes cameras 42 mounted on one or more horizontal bars to monitor the quality of the coating material being applied to the items C. FIG. 15 shows two fixtures F and parts C at the start inspection position. FIG. 16 shows the two fixtures F and defective items C gripped by grippers 96 of the defective part rejection system 24, and turned nearly to a half-way point before rejection or dumping of the rejected items C for failure to meet the necessary coating quality standards. FIG. 17 shows the grippers 96 past the half way point prior to dumping. FIG. 18 shows the grippers 96 in a completely upside down position for release or dumping of the rejected items C into a take-away bin located below the component 24.

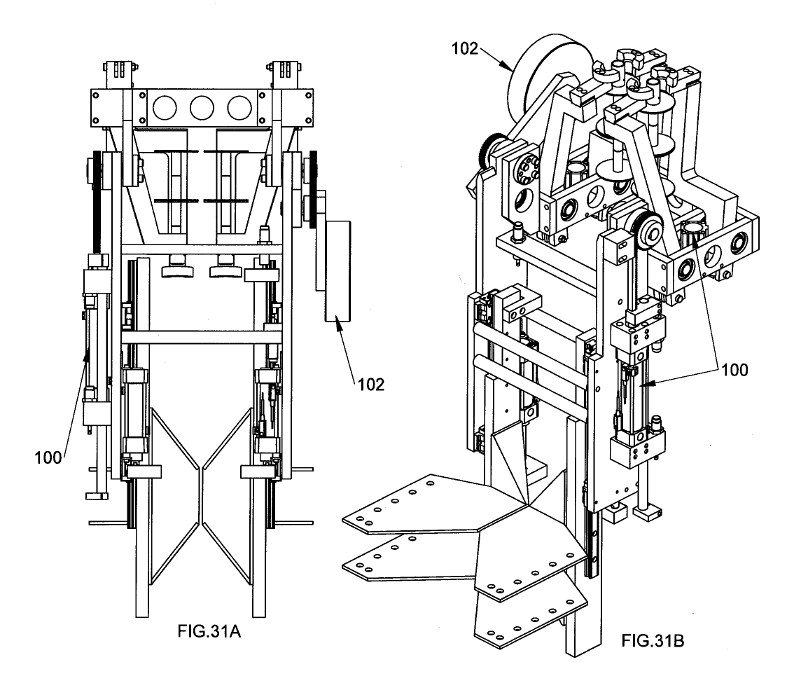

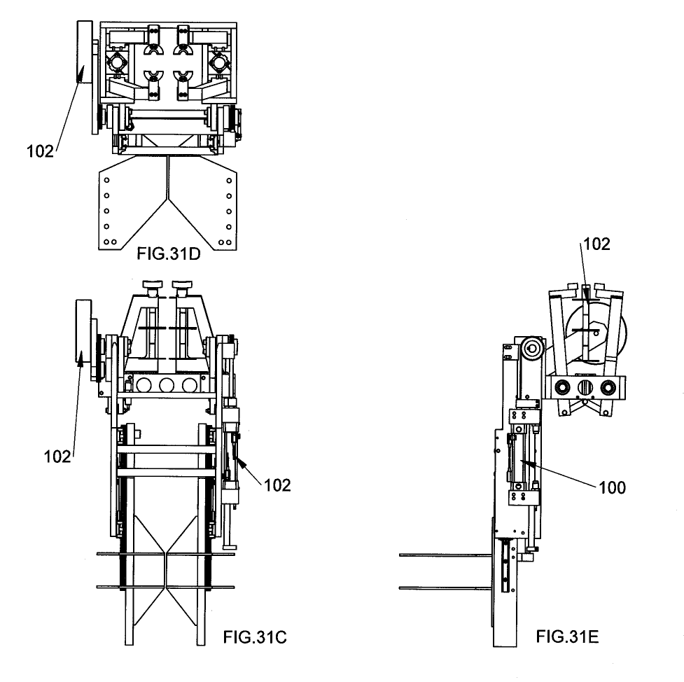

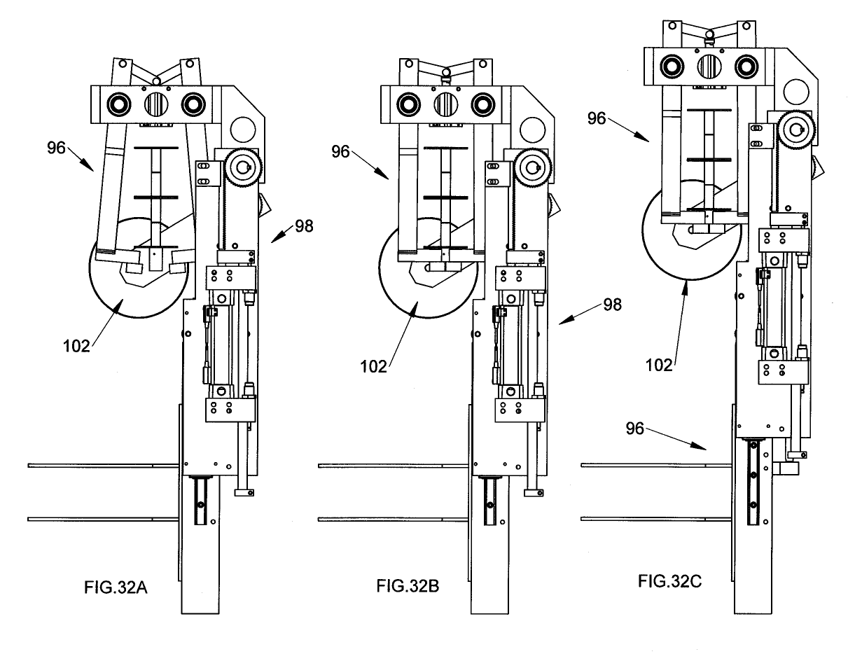

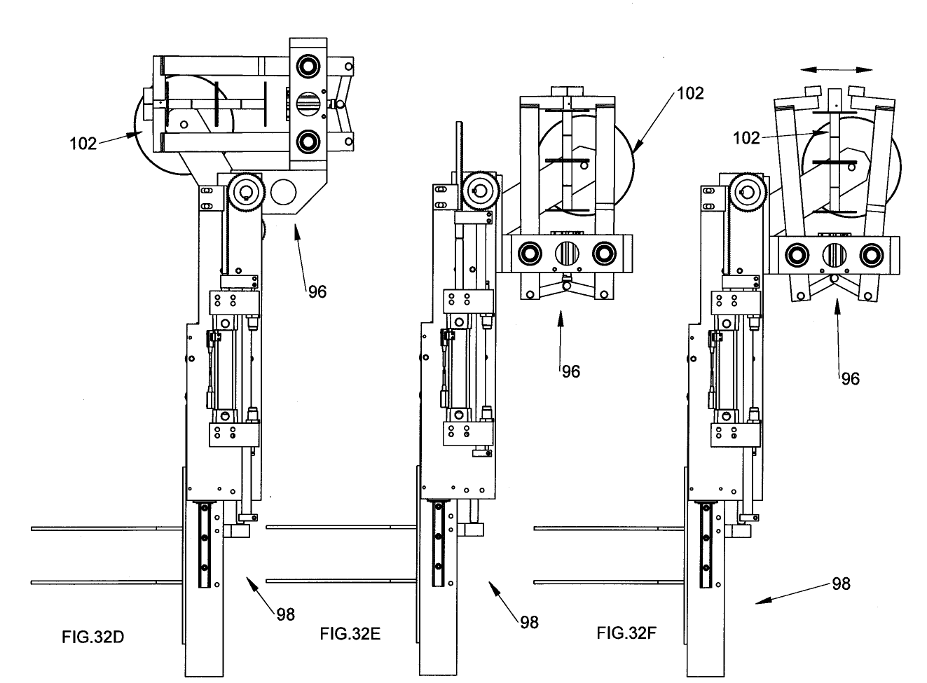

FIGS. 31a to 31e and FIGS. 32a to 32e provide additional illustrations of the automated defective part rejection system component 24. As shown in the front view of FIG. 31a, in a camera inspection system view, parts are positioned on spindles 28 intermediate a pneumatically controlled gripper mechanism 96 having a linkage which is actuated to open and close the gripper jaws. The gripper mechanism 96 is supported on a pneumatically controlled horizontal lifting mechanism 98. The gripper mechanism 96 grips defective parts, lifts and rotates the items C through a 180 degree motion as shown in FIGS. 32a to 32e using a balanced counterweight 102. The operating pneumatic cylinders 100 are supported as shown on the mechanisms. FIG. 31b illustrates the horizontal lifting mechanism 98 and gripper mechanism 96 in a dump, release or eject position for removal of rejected parts. FIGS. 31c to 31e illustrate the top, front and side views of the dump, release or eject position. FIGS. 32a to 32b illustrate positions or movements of the automated defective part rejection system 24 from the start position to the release position.

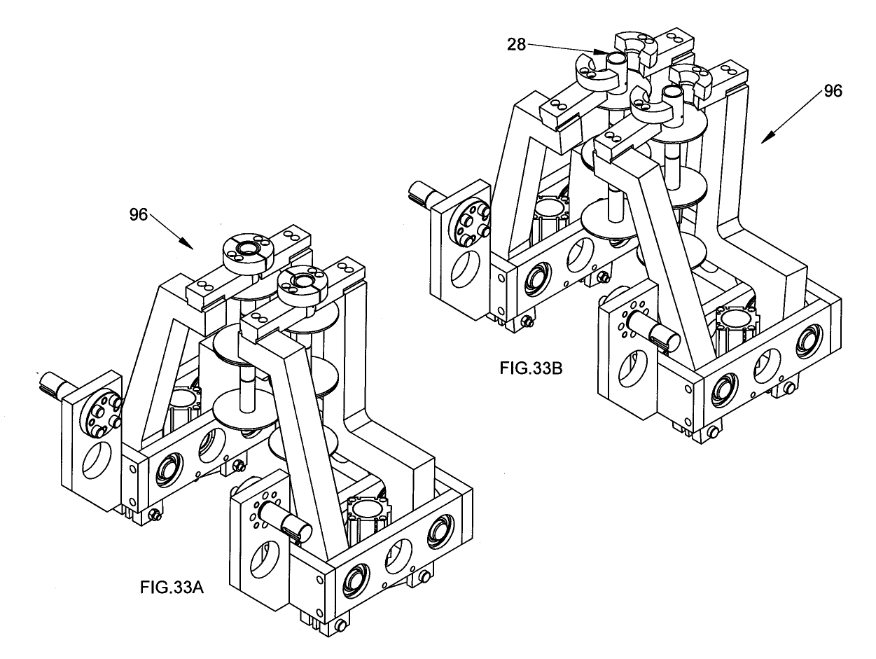

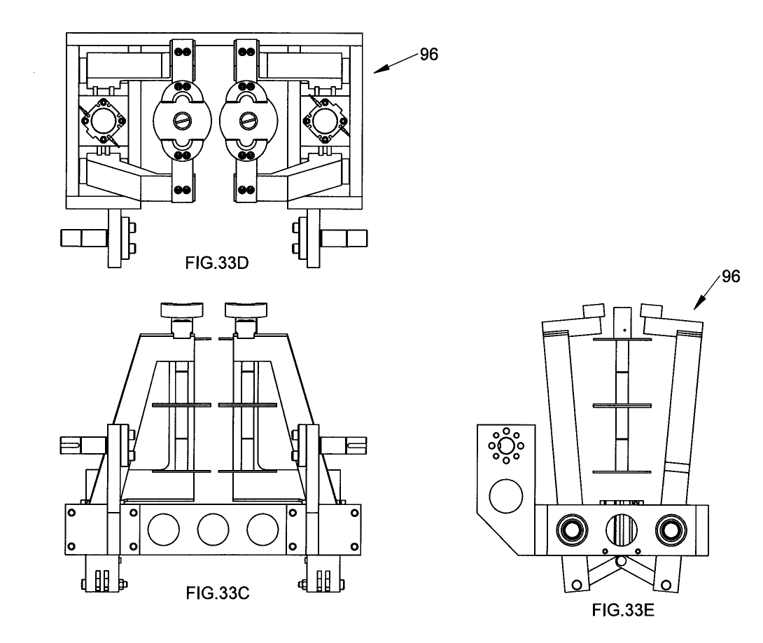

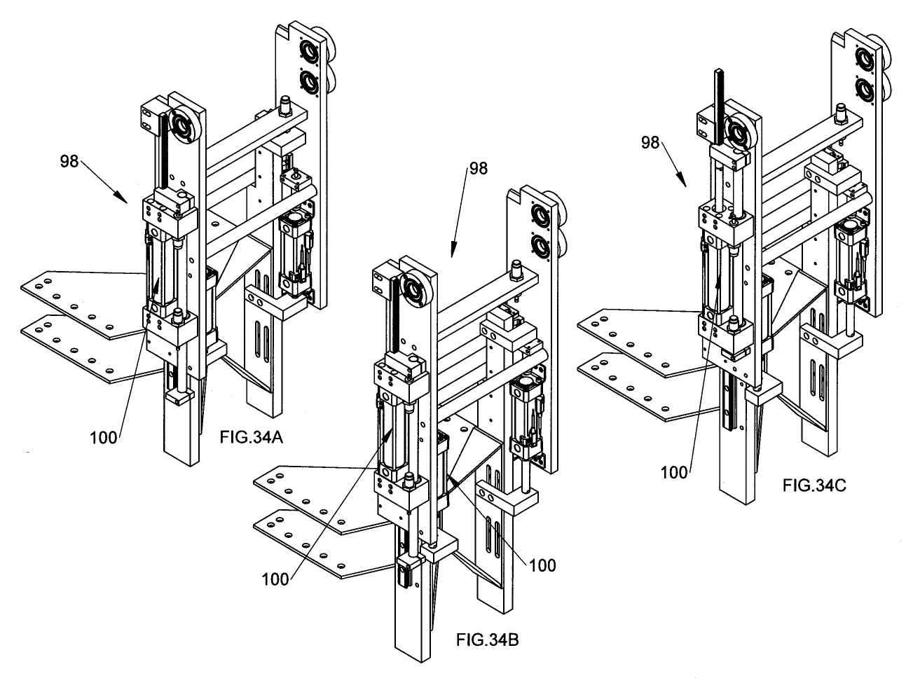

FIGS. 33a to 33e illustrate, in upside down view or position, the gripper mechanism 96 in grip position, release position, bottom view, side view, front view and side view, respectively. FIGS. 34a to 34c show the horizontal lifting mechanism 98 which supports the gripper mechanism 96, from the start position to the release or dump position.

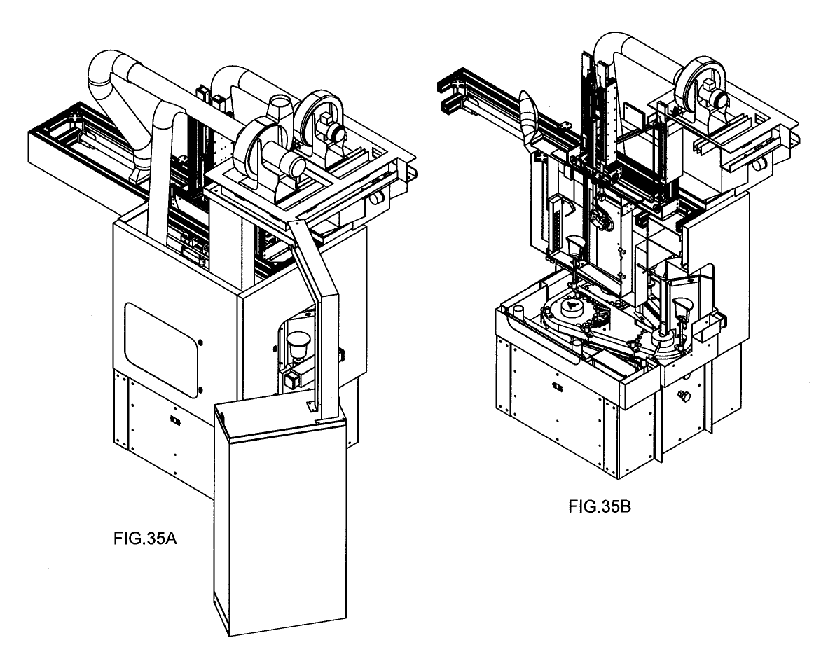

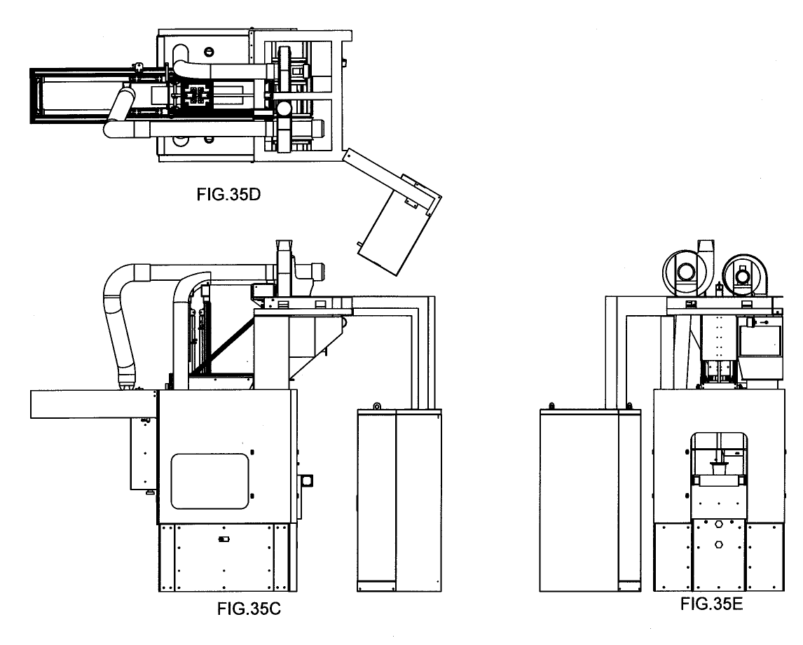

FIGS. 35a to 35e shows a smaller version of a spindle spray coating system 10′, which makes use of a closed spray booth component 20′ having only a single spray gun 50′ and 8 spindles 28′ which are conveyed through similar components to the system previously described, but on a smaller scale.

I claim:

1. A spindle spray coating system, comprising:
a spindle conveyor system component for horizontally transporting parts supported on spindles within the system;
a spindle rotation station assembly for rotating individual spindles supporting parts during a spray operation; and
a spray containment closed spray booth having an open position for moving parts into the closed spray booth supported on the spindle conveyor system and a closed position for containment of parts supported on spindles during the spray operation to minimize environmental and operator exposure to the coating materials being sprayed.

2. A spindle spray coating system, comprising:
a spindle conveyor system component for horizontally transporting parts supported on spindles within the system;
a preheat component for preheating parts supported on spindles within the system prior to spray coating;
a spindle rotation station assembly for rotating individual spindles supporting parts during spraying
a spray containment closed spray booth for containment of parts supported on spindles during the spray operation by an adjustable spray system to minimize environmental and operator exposure to the coating materials being sprayed;
a vision inspection system for determining whether the parts supported on the spindles were coated during the spray operation; and
an automated defective part rejection assembly.

3. The spindle spray coating system of claims 1 or 2 further comprising a second spray containment closed spray booth for containment of parts supported on spindles during a secondary spray operation by a secondary spray system.

4. A spindle rotation drive assembly having a first open position for loading spindles to be rotated, and a second position for engagement with spindles to be rotated, said spindle rotation drive assembly comprising a first drive belt driven by a motor and gear mechanism, said first drive belt for engagement along one side of the spindles to be rotated, and a second drive belt for engagement along an opposite side of the spindles to be rotated, whereupon rotation of the first driven drive belt, rotates the second drive belt, to equalize the forces applied to the spindles being rotated.

5. An automated defective part rejection assembly comprising a vertically lifting mechanism, and a gripper mechanism for gripping defective parts, lifting and rotating the parts through a 180 degree motion using a balanced counterweight, followed by release of the parts from the gripper mechanism for disposal.
